(19) United States
(12) Patent Application Publication
(10) Pub. No.: US 2022/0138846 A1
(43) Pub. Date: May 5, 2022

(54) METHOD AND APPARATUS FOR UNDERWRITING LOANS

(71) Applicant: Chris Karageuzian, Burbank, CA (US)

(72) Inventor: Chris Karageuzian, Burbank, CA (US)

(21) Appl. No.: 17/520,577

(22) Filed: Nov. 5, 2021

Related U.S. Application Data
(60) Provisional application No. 63/110,230, filed on Nov. 5, 2020.

(51) Int. Cl. G06Q 40/02; G06K 9/00; G06F 40/174; G06Q 30/02

(52) U.S. Cl. CPC G06Q 40/025; G06K 9/00449; G06K 2209/01; G06Q 30/0282; G06F 40/174

(57) ABSTRACT

The system provides a platform that automates matching and underwriting for a plurality of lenders. The system provides a normalized loan application and can convert non-conforming applications to a normalized application via an Optical Character Recognition (OCR) feature. The system integrates borrowers, lenders, and brokers to allow for easy access to multiple loan transactions. Borrowers benefit from a single application and exposure to multiple lenders. The matching algorithm of the system ensures that only those lenders and borrowers who can close a loan are matched. The borrower can shop rates, services, loan terms, and the like to find the best loan. Lenders can access multiple potential borrowers and determine metrics to maximize the lender's chance to match with borrowers. Lenders can also see loans in progress, team member performance, and financial data. Brokers can see full data on loan checks, historical data, cash flow management, and the like.

This patent application claims priority to U.S. Provisional Patent Application 63/110,230 filed on Nov. 5, 2020, which is incorporated by reference herein in its entirety.

### BACKGROUND OF THE SYSTEM

The loan process for a consumer is an inefficient operation that requires repeated input of the same data to different institutions. Many of the limitations of the current system are imposed by its de-centralized nature. Each lending institution has its own forms and procedures related to the loan process and requires applicants to use their custom forms. For a consumer applying for loans at multiple institutions, this leads to repetition and resubmission of the same data multiple times, with each submission and receipt having the potential for transcription errors and delays.

There is a trust and verification problem with the loan process because financial institutions cannot simply trust data provided to them by a consumer. The institution must independently verify the consumer data, adding cost and complexity to the process of making a risk decision about a loan. This effort is typically done manually, with staff reading documentation and reconciling the information provided by the consumer with data from trusted sources. As a result, institutions incur significant costs procuring and verifying documentation in an attempt to verify consumer data when making a risk decision. The documentation can be in the hundreds of pages, including bank statements, tax returns, proof of income, and the like, just to verify the consumer's stated assets and income. This adds cost, delay, and friction to the risk decision process.

The consumer also faces problems in the loan process. Often a consumer must access different systems (with the help of some third party, such as a credit reporting agency) to determine if the consumer's own data is accurate as to income, credit, payment history, and the like. The consumer may need to access a credit history source or have a credit check done to make sure their credit is as clean as possible and without errors and/or misassigned credit transactions.

The current process adds significant time to the decision to underwrite a loan. It can take over twenty-one days on average to underwrite a loan. Currently, there has been some effort to unify the loan process, mostly by online banks. However, none of the solutions have solved the problems. For example, current attempts at solutions are single product solutions that do not have general applicability to different types of loans and/or different lenders.

### SUMMARY

The system provides a platform that automates matching and underwriting for a plurality of lenders. The system provides a normalized loan application and can convert non-conforming applications to a normalized application via an Optical Character Recognition (OCR) feature. The system integrates borrowers, lenders, and brokers to allow for easy access to multiple loan transactions. Borrowers benefit from a single application and exposure to multiple lenders. The matching algorithm of the system ensures that only those lenders and borrowers who can close a loan are matched. The borrower can shop rates, services, loan terms, and the like to find the best loan. Lenders can access multiple potential borrowers and determine metrics to maximize the lender's chance to match with borrowers. Lenders can also see loans in progress, team member performance, and financial data. Brokers can see full data on loan checks, historical data, cash flow management, and the like.

### BRIEF DESCRIPTION OF THE DRAWINGS

FIG. 1 is a flow diagram illustrating the operation of the system in an embodiment.

FIG. 2 is a flow diagram illustrating a loan check process in an embodiment of the system.

FIG. 3 is a flow diagram illustrating the automated underwriting process of the system in an embodiment.

FIG. 4 is functional block diagram of an embodiment of the system.

FIG. 5 is a flow diagram illustrating the step of normalizing data in one embodiment.

FIG. 6 is flow diagram illustrating a matching operation in an embodiment.

FIG. 7 is a flow diagram illustrating machine learning and artificial intelligence in an embodiment of the system.

FIG. 8 is an example processing environment for implementing an embodiment of the system.

### DETAILED DESCRIPTION OF THE SYSTEM

The system provides a platform for lenders, brokers, and consumers to handle any type of loan request, including commercial, business, residential, and personal. The system provides a bigger lending market to brokers and consumers, better deals due to transparency and competition, better rates, and quicker underwriting time frames.

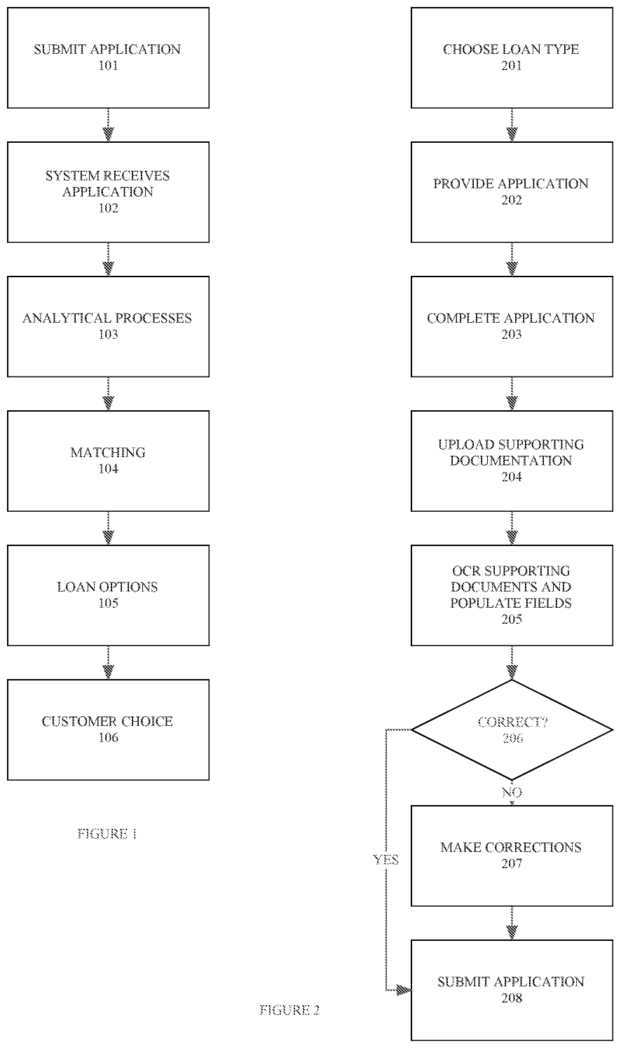

FIG. 1 illustrates the flow of a transaction in an embodiment of the system. At step 101 a loan application is submitted to the platform. In one embodiment, the applications are submitted by consumers seeking a loan, loan brokers, banks, and the like. The application can be for a commercial loan, business loan, residential loan, personal loan, and the like. The system includes a dashboard where the user can upload documents to make the loan application easier. The system can scan the documents and auto-populate fields. The application is designed so that it can be easily used by multiple lenders without requiring separate applications for each one. The consumer at this step can also set metrics and terms for the loan, including interest rate, principal requested, term, and the like.

At step 102 the system receives the application. In one embodiment, all consumer submissions on the platform come to the system for the system to close on its transactional platform. Brokers will use the platform for their own leads and clientele and for their current product offerings, while allowing them to expand into new products (e.g. a broker who did residential can now do commercial as well). Residential loan brokers who previously had to refer out commercial loans can now service those loans via the system and capture revenue that was previously unavailable. Banks can use the system to close their own leads as well. The Banks and Brokers can direct their own leads to the system and close those loans.

At step 103 the system applies analytics and algorithms to the loan application. This may include using databases to check assertions made in the loan application, including value of assets, ownership of assets, credit score, and the like. At step 104 the loan application undergoes the matching process where a plurality of lenders can be shopped at the same time (often in seconds). The system matches the loan application with lenders and in one embodiment requires a threshold level of matching loan metrics (e.g., a 95% match) so that no time is wasted on lenders who don't want the loan or borrowers who don't want the lender. The lenders on the system have set parameters for loan metrics that they are willing to fund, including credit score of the borrower, term, interest rate, value of collateral, and the like. Similarly, the borrower has indicated metrics that they desire and/or require in the loan, including term, interest rate, type of rate (variable, fixed), and other metrics.

At step 105 the consumer is presented with loan options that have been generated at step 104. For a consumer who came directly to the system, the system itself may close the loan in an embodiment. In one embodiment, the consumer is presented with offers and/or broker agreement generated by the system matching process. The consumer chooses a lender is then submitted through the platform to the lender they choose. If the consumer is a Broker client, the Broker will interact with lenders and the system to find suitable loans. If the consumer came via a Bank, the Bank presents the consumer with its loan offering at step 105. The consumer picks a loan at step 106.

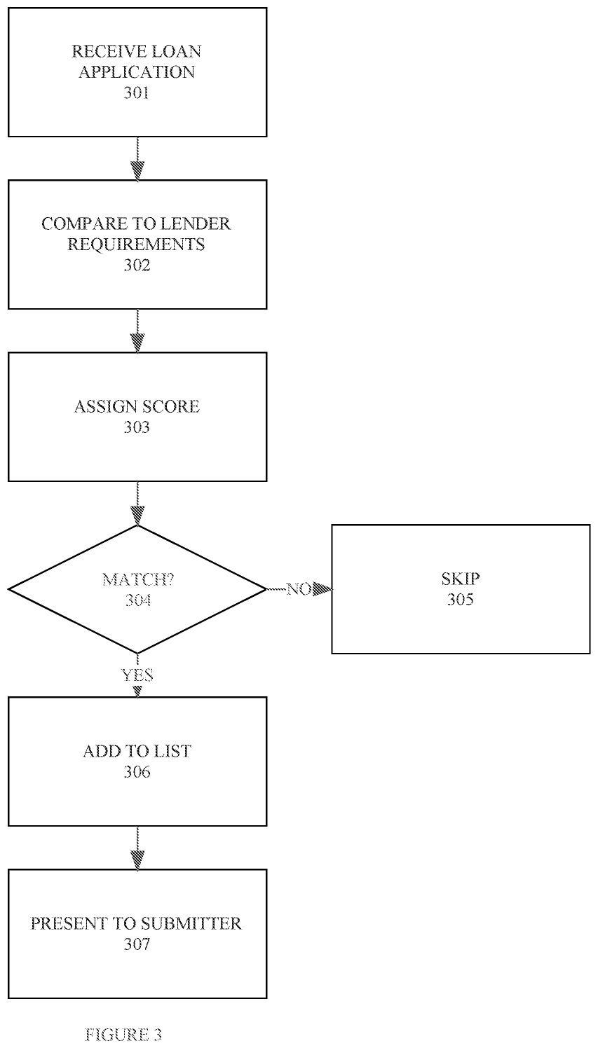

FIG. 2 is a flow diagram illustrating the loan check process in an embodiment of the system. The loan check process can be initiated by a consumer. In one embodiment, a broker will direct a client borrower to the loan check process. At step 201 the consumer selects a loan type (e.g. commercial, business, residential, personal, and the like). At step 202 the system provides the appropriate loan application to the consumer. The loan application is presented on-line and includes help support and instructions for each field of the application. In one embodiment, the consumer completes a system provided Personal Financial Statement (PFS) either online, or by hand. The system can then retrieve the data and populate the loan application for the applicant, either by direct transfer of the online information or by OCRing the hand completed PFS. The system then prompts the consumer for additional information. For example, the system may identify those tax forms and lines that contain requested information. At step 203 the consumer completes the application. The system may provide help information in a pop up or overlay when the consumer hovers the mouse over fields to be completed.

At step 204 the system requests, and the consumer provides, supporting documentation. This can include tax returns, pay stubs, W-2s, K-1s, proof of residence, mortgage statements, Personal Financial Statement, Debt Schedule, P&L statement, Balance Sheet, 1003 documents, loan documents, and the like.

At step 205 the system applies a custom OCR process to the documents and extracts needed information and populates appropriate fields in the digital version of the application. The system can also interface with credit reporting agencies during this process and download the consumer's credit reports (pursuant to permissions and opt-ins from the consumer). The system can also integrate third party services that related to the loan process, including escrow, appraisals, title insurance, and the like. The system can be the interface for communication between the system and the third parties, even automatically ordering required services. The system can also send reminders to participants to complete tasks needed for loan processing and to not proceed until confirmation is received.

At decision block 206 the system presents the normalized information to the consumer to see if it is correct. In addition, the system can check if entered information (e.g. income amounts from tax forms) matches what the consumer entered. If not, the system proceeds to step 207 where the consumer provides any needed corrections. After step 207, or if the information is correct at step 206, the system proceeds to step 208 and submits the loan application for review, such as the matching step 104 in FIG. 1.

The loan check process is an advantage for brokers who can avoid any need for managing and maintaining loan applications, and can take advantage of the system features for providing loan access to customers. The system includes customer relationship management (CRM) features to allow easy communication between the broker and client. The system also stores financial data and information for the customer to eliminate the need to repeatedly ask the customer for the same documentation and data. The system will also store all loan closings, loan checks, matchings, submissions, approvals, declines, and the like.

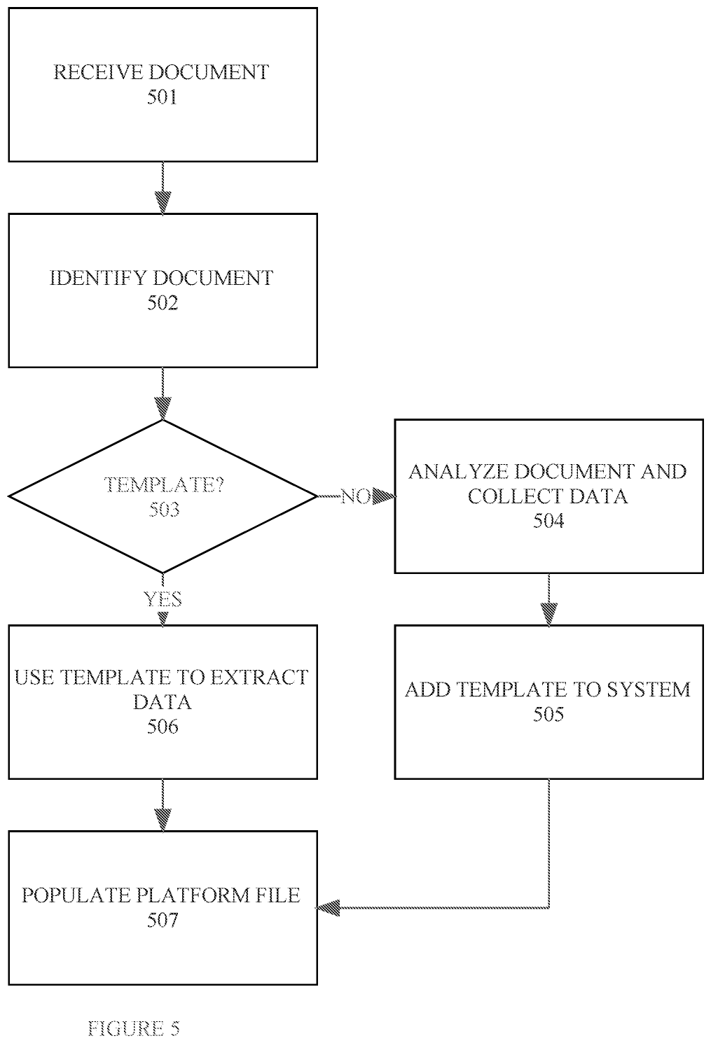

FIG. 5 is a flow diagram illustrating the OCR step in an embodiment of the system. At step 501 a document is presented and scanned into to the system. The document could be a tax document, bank statement, paycheck stub, mortgage document, P&L, loan application, PFS, and the like. The scanning may be to convert the document to a desired file type, such as a .pdf file, word document, html document, and the like.

At step 502 the system identifies the document. The document submission process may include a request for data related to the document, such as the type of document, form number, issuing institution, and the like, which is then attached as metadata to the scan of the document. In some cases, the metadata is sufficient to identify the document with particularity. If the metadata is not sufficient to positively identify the document, the system looks for identifying information on the scanned document. This may include the title of the document, form number information in headers or footers, key words and the like.

After the document is identified at step 502, the system proceeds to decision block 503 to determine if the system has a template on hand for retrieving data from the document. For example, if the document is identified as a 1040 Federal Tax Return, the system will have a template to know in advance where to look for information and what fields of information are important to the process.

If there is no template at decision block 503 the system analyses the document and extracts keywords and values to identify relevant data. For example, the user may submit a previously completed loan application and wants to submit that document to save time in completing the system application. If it is a case of first impression of this document for the system, the platform will analyze the document and collect the data at step 504. At step 505 the system will add the new template to the database of the platform for future use. The system then proceeds to step 507 and populates the data in the appropriate places in an associated user file in the system.

If the system does have a template for the document at decision block 503, the system proceeds to step 506 and uses the template to extract the appropriate data from the document. The system then proceeds to step 507 and populates the data in the appropriate places in an associated user file in the system. The data is maintained in the system database so that if the same user applies for a loan again, the system can autopopulate the application with previously collected information that is still usable.

The system performs automatic underwriting of loans, further streamlining the loan process. The underwriting process in an embodiment of the system is illustrated in FIG. 3. At step 301 the system receives a loan application. At step 302 the system compares the loan application (e.g. amount, purpose, down payment, assets, credit score of borrower, and the like) to lender defined requirements for the underwriting process.

At step 303 the system assigns a score showing the degree of matching between the loan application and the underwriting requirements. In one embodiment, this is implemented by checking off completed and/or satisfied loan parameters and displaying the final loan matching score on the appropriate dashboard. In one embodiment, the parameters can include global cash flow, business cash flow, debt to income ratio (DTI), FICO, loan to value (LTV), global cash flow, debt service coverage ratio, and the like. At decision block 304 it is determined if the score is above a pre-determined threshold number for automatic underwriting. In one embodiment, the system requires a score that represents a 95% match for automatic underwriting.

In one embodiment, the scoring is accomplished by comparing the metrics of the loan to other applications that have the same metrics. If those other matching loans were underwritten at the threshold level (e.g., 95%) then the system will offer the highest scoring loan offers to the consumer.

If there is no match at step 304, the system moves to step 305 and skips that lender. If there is a match at step 304, the system adds that lender to the list at step 306. At step 307, all matching lenders are presented to the submitter (e.g., broker/consumer). In one embodiment, the matching step may be performed based on data obtained prior to the OCR step. If the information provided on the loan application does not meet any minimum requirements of a lender, or, if the loan parameters requested by the borrower simply don't exist, there is no need to proceed to the OCR step.

If there are no lenders available that result in the threshold funding level, the consumer will be presented with a dashboard via the system that allows them to modify loan parameters. The system can then reveal if the changes will result in a loan score that provides at least one lender for the consumer. In one embodiment, the system can provide help to the consumer and indicate values and levels of the metrics that would result in a fundable loan at the desired threshold score.

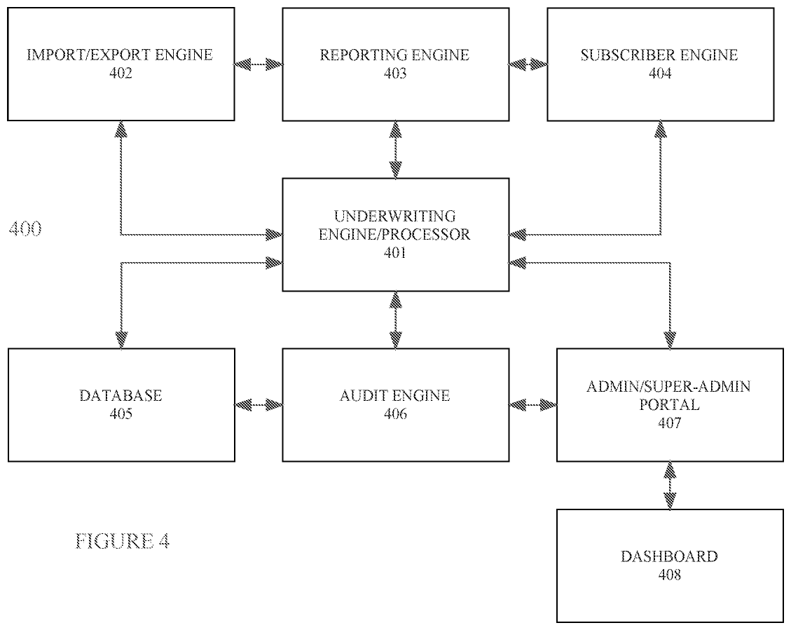

FIG. 4 is a functional block diagram illustrating the system in an embodiment. Underwriting Engine/Processor 401 is used to compare loan metrics to lender requirements as described in FIG. 3 and to provide automatic underwriting. This element also implements the loan check process. Data (including lender profiles, requirements, loan apps, and the like) is stored in Database 405. Database 405 can also store financial data and information for the customer to eliminate the need to repeatedly ask the customer for the same documentation and data. The system will also store all loan closings, loan checks, matchings, submissions, approvals, declines, and the like in Database 405.

Import/Export Engine 402 provides the path for data to come in and out of the system. Audit Engine 406 is used to track transactions and to provide an audit trail for the system. Reporting Engine 403 provides the ability to generate custom reports for the lenders, brokers, and other subscribers to the system.

Admin/Super-Admin Portal 407 accesses all data and is used by the system to aid in operation. Some of the data is available to different users (brokers, banks, borrowers, and the like) and is available at Dashboard 408. Dashboard 408 represents different access and permissions depending on the user.

In one embodiment the system includes machine learning/artificial intelligence that can ingest the entire loan and lending history of system participants. The system can then have the institutional knowledge of all system participants in one platform, allowing it to make predictions, decisions, and automatic underwriting approvals with high precision. This information can be in the millions of transactions and results in a system with more and better knowledge than any human participant. This ingestion can be done via Import/Export Engine 402 and the machine learning can be implemented in the Underwriting Engine/Processor 401.

The Import/Export Engine 402 and the Dashboard 408 can both include voice command capability to allow a user to easily order appraisals, email loan documents, initiate escrow and title, and other tasks that can be initiated by voice command.

The system can automatically generate QR codes, bar codes, and the like to identify large volumes of materials so that the data can be accessible more easily for current deals and as historicals from third party reports and/or bank data for future deals. This can also apply to third party reports and other property data. In one embodiment, the system permits users to use cameras to scan the properties along with third party materials to underwrite and match properties to the correct lender.

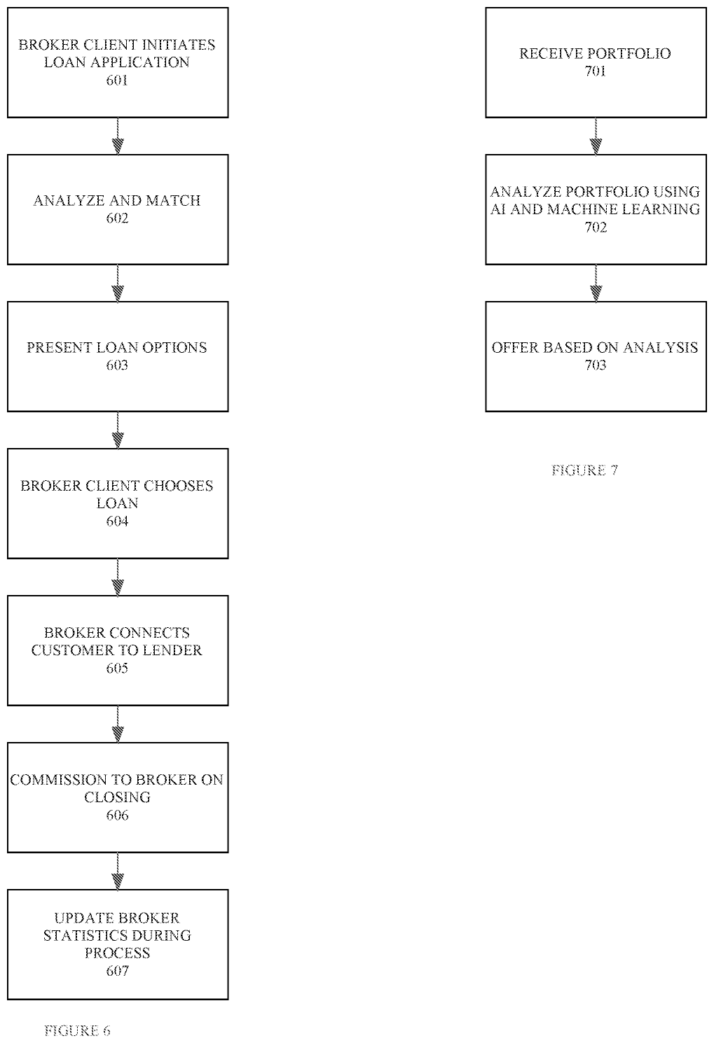

FIG. 6 is a flow diagram illustrating the operation of the system for brokers in an embodiment. A loan broker may be an individual or one of a plurality of brokers in a company. The brokers have clients who desire to borrow money. The broker may use the platform, or a broker version of the platform, and have the client initiate a loan application at step 601. The loan application uses the platform loan application system, including the OCR feature, to help generate and autopopulate the loan application. At step 602 the system submits the loan application to the platform for analysis, scoring, and matching.

At step 603 the platform presents loan options to the broker and the broker client. The client chooses a loan at step 604 and the broker connects the broker client and the lender at step 605. This connection is done via the platform, as the lender is also a participant in the platform and system. The lender uses the system and their own internal processes to close the loan and the broker is paid a commission upon closing at step 606.

At step 607, the system updates statistics and status of the loan during the process and after completion. The statistics are associated with the broker, broker company, borrower, and lender. The statistics and data can be accessed via a portal specific to each type of user. The brokers/broker company and lender can access a portal to see a trail of activity for each transaction.

The broker company and lender can create loan checks for their respective portals as desired. An underwriter could edit loan applications submitted to them if necessary. A broker can see full performance and productivity statistics for the company and any brokers or groups of brokers as desired. Notes can be added to the data as desired by the participants as desired. In one embodiment, the system allows any user to modify options for comparison. For example, a borrower may desire a five year loan but is willing to look at options for a seven year loan as well. This allows comparison borrowing without being limited to a single set of parameters.

A borrower portal does not have as many options for statistics as for the broker lender portal. The borrower portal allows the borrower to check the status of the loan process. The borrow might also be sent messages or reminders of missing documents or information needed to complete the loan process.

The system can also implement AI portfolio management which can monitor all loans at all times. Based on loan participant actions and behavior, external data (economic conditions, financial data, market conditions, and the like) and other data, the system can predict risks to the portfolio of non-performance. The system can also monitor the loan process in real time and use machine learned historical data to identify bottlenecks, slow responses, miscommunication, and the like to help process loans or to steer the loan elsewhere if appropriate.

FIG. 7 is a flow diagram illustrating the operation of Artificial Intelligence or machine learning in an embodiment of the system. At step 701 a lender submits a loan portfolio for analysis. At step 702 the system uses current market rates, institutional and regulatory guidelines to offer purchase options of the portfolio to the lender. The system uses all transactions that have been performed by the system, for all lenders. In addition, the ingestion system of the platform allows it to accept past transactions from member lenders, even if they are not in the current preferred format of the system. This provides an extensive database of information for the machine learning system.

At step 703 the system provides an offer for the portfolio that may be an outright purchase or a system of refinancing to control risk of nonperformance, rate the quality of renewals, and to better serve clients. The AI can also be applied to an individual borrower to determine if a revised payment schedule, refinancing, or other palliative measures can be offered to maximize the likelihood of loan repayment.

The system also allows other financial instruments and products to be offered, marketed, and consumed via the platform.

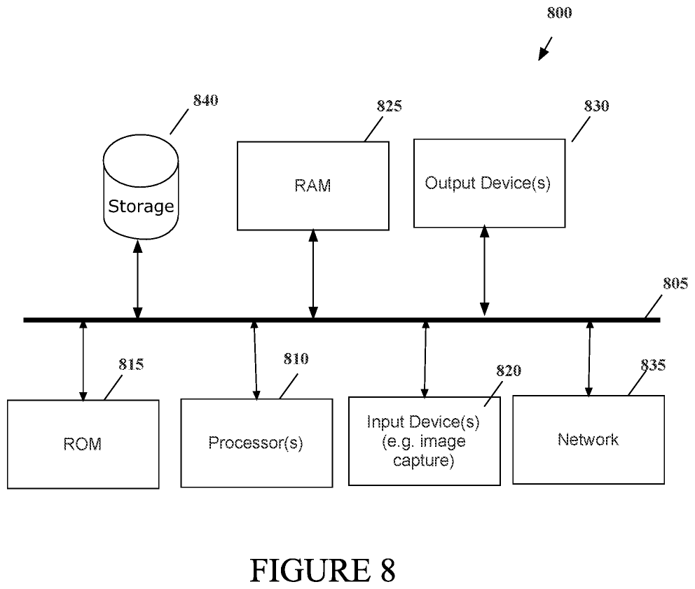

FIG. 8 illustrates an exemplary a system 800 that may implement the system. The electronic system 800 of some embodiments may be a mobile apparatus. The electronic system includes various types of machine readable media and interfaces. The electronic system includes a bus 805, processor(s) 810, read only memory (ROM) 815, input device(s) 820, random access memory (RAM) 825, output device(s) 830, a network component 835, and a permanent storage device 840.

The bus 805 communicatively connects the internal devices and/or components of the electronic system. For instance, the bus 805 communicatively connects the processor(s) 810 with the ROM 815, the RAM 825, and the permanent storage 840. The processor(s) 810 retrieve instructions from the memory units to execute processes of the invention.

The processor(s) 810 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 810, they cause the processor(s) 810 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 810. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 800, define one or more specific machine implementations that execute and perform the operations of the software programs.

The ROM 815 stores static instructions needed by the processor(s) 810 and other components of the electronic system. The ROM may store the instructions necessary for the processor(s) 810 to execute the processes provided by the system. The permanent storage 840 is a non-volatile memory that stores instructions and data when the electronic system 800 is on or off. The permanent storage 840 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 825 is a volatile read/write memory. The RAM 825 stores instructions needed by the processor(s) 810 at runtime, the RAM 825 may also store the real-time video or still images acquired by the system. The bus 805 also connects input and output devices 820 and 830. The input devices enable the user to communicate information and select commands to the electronic system. The input devices 820 may be a keypad, image capture apparatus, or a touch screen display capable of receiving touch interactions. The output device(s) 830 display images generated by the electronic system. The output devices may include printers or display devices such as monitors.

The bus 805 also couples the electronic system to a network 835. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 18(f) unless the element is expressly recited using the phrase “means for” or, in the case of a method claim, the element is recited using the phrase “step for.”

Thus, an automated loan system has been described.

What is claimed is:

1. A method for providing automated loan underwriting comprising:
receiving a personal financial statement (PFS) from a user as part of a request for a loan;
scanning the PFS for relevant data;
using the data to generate metrics associated with the loan;
comparing the metrics with the same metrics from loan applications from a plurality of lenders;
determining the percentage of past loans that have been funded with the same metrics;
offering to the user all loans that have been funded at a threshold percentage.

2. The method of claim 1 wherein the scanning of the PFS comprises an OCR operation.

3. The method of claim 1 wherein the metrics comprise global cash flow, debt to income, debt service coverage ratio, and loan to value percentage.

4. The method of claim 1 wherein the threshold percentage is at least 95%.

5. The method of claim 2 further including submitting one or more supporting documents to the loan request.

6. The method of claim 5 further including performing an OCR operation on each of the one or more supporting documents.

7. The method of claim 6 comprising using metadata associated with each supporting document to identify the supporting document.

8. The method of claim 1 further including a camera to scan properties with associated third party materials to underwrite and match properties to a correct lender.
